(19) United States
(12) Patent Application Publication
(10) Pub. No.: US 2007/0047147 A1
(43) Pub. Date: Mar. 1, 2007

(54) Actuator of optical pickup head with horizontal-arranged magnetic field generator and coil apparatus

(75) Inventor: Pei-Ching Kuo, Taipei (TW)

Correspondence Address: BIRCH STEWART KOLASCH & BIRCH, PO BOX 747, FALLS CHURCH, VA, 22040-0747, US

(73) Assignee: Lite-On It Corporation

(21) Appl. No.: 11/480,872

(22) Filed: Jul. 6, 2006

(30) Foreign Application Priority Data
Aug. 29, 2005 (TW) 94129550

(51) Int. Cl. G11B 5/48

(52) U.S. Cl. 360/240

(57) ABSTRACT

An actuator of an optical pickup head with horizontal-arranged magnetic field generator and coil apparatus. The actuator includes a lens holder, a magnetic field generator and a coil apparatus. The coil apparatus is horizontally disposed at one side or two sides of the lens holder and includes a focusing coil and a tracking coil, which are disposed on the same horizontal plane. The magnetic field generator includes a first magnet and a second magnet. The lens holder is horizontally placed between the first magnet and the second magnet. The first magnet and the second magnet respectively have a first magnetic area, a second magnetic area, a third magnetic area, a fourth magnetic area and a fifth magnetic area. Selecting different polarities of the magnetic surface near the coil apparatus in each area can produce a first magnetic field and a second magnetic field that are perpendicular to each other.

This application claims the benefit of Taiwan application Serial No. 94129550, filed Aug. 29, 2005, the subject matter of which is incorporated herein by reference.

### BACKGROUND OF THE INVENTION

1. Field of the Invention

The invention relates in general to an actuator of an optical pickup head, and more particularly to an actuator of an optical pickup head having horizontal-arranged magnetic field generator and coil apparatus.

2. Description of the Related Art

In the information-explosion era, most multimedia products are issued by way of disk. The optical pickup head for reading data from the disk or writing data into the disk naturally plays an indispensable and important role in the modern data-accessing technology.

FIG. 1 is a top view showing a conventional actuator of an optical pickup head. FIG. 2 is a side view showing the conventional actuator of the optical pickup head. FIG. 3 is a pictorial view showing the conventional actuator of the optical pickup head. Referring simultaneously to FIGS. 1 to 3, an actuator 100 of an optical pickup head includes a lens holder (not shown), a magnetic field generator, a focusing coil 132 and a tracking coil 134. The lens holder holds a lens, which focuses light generated by a semiconductor laser onto a disk that stores a lot of data, so that the optical pickup head can write data into the disk or read data from the disk.

The magnetic field generator includes a first magnet 122, a first yoke 123, a second magnet 124 and a second yoke 125. The magnetic surface of the second magnet 124 faces the magnetic surface of the first magnet 122. The magnetic surface of the first magnet 122 and the magnetic surface of the second magnet 124 near the tracking coil 134 have the same polarity, such as the N or S polarity. The interaction between the first magnet 122 and the first yoke 123 and the interaction between the second magnet 124 and the second yoke 125 enable the magnetic field generator to generate a magnetic field with a fixed direction between the first magnet 122 and the first yoke 123 and another magnetic field with another fixed direction between the second magnet 124 and the second yoke 125.

The focusing coil 132 is disposed between the first magnet 122 and the second magnet 124, and the plane of the focusing coil 132 is perpendicular to the magnetic surfaces of the first magnet 122 and the second magnet 124. When the focusing coil 132 is introducing the current, the focusing coil 132 generates a second reaction force, which forces the lens holder to move along a focusing direction, according to the current and the magnetic field.

The tracking coil 134 is disposed between the focusing coil 132 and the first magnet 122 and between the focusing coil 132 and the second magnet 124. The plane of the tracking coil 134 is parallel to the magnetic surfaces of the first magnet 122 and the second magnet 124. When the tracking coil 134 is introducing the current, the tracking coil 134 generates a first reaction force, which forces the lens holder to move along a tracking direction, according to the current and the magnetic field.

Alternatively, as disclosed in U.S. Pat. No. 6,744,722, two magnets that are disposed such that the magnets are perpendicular to each other are used. The focusing coil and the tracking coil respectively corresponding to the magnets are also disposed in a manner such that the coils are perpendicular to each other in the actuator of the optical pickup head. The focusing coil, the tracking coil and the magnetic field generator are disposed vertically in order to drive the actuator to move along the focusing direction and the tracking direction.

In order to generate the first reaction force and the second reaction force which are perpendicular to each other in the conventional actuator so as to move the lens holder along the focusing direction and the tracking direction, however, the designer has to design the mechanism for making the planes of the focusing coil and the tracking coil perpendicular to each other. Thus, the wire winding processes of the focusing coil and the tracking coil are complicated, and the manufacturing time and cost are respectively lengthened and increased. Consequently, the size and thickness of the actuator cannot be effectively reduced, thereby limiting the application of the optical pickup head to the small form factor optical disk drive (SFFO).

### SUMMARY OF THE INVENTION

It is therefore an object of the invention to provide an actuator of an optical pickup head having horizontal-arranged magnetic field generator and coil apparatus. The magnetic field generator has different polarities on the same magnetic surface thereof, generates two magnetic fields with directions that are perpendicular to each other, and thus generates a first reaction force and a second reaction force for the lens holder to move along focusing direction and tracking direction. Thus, a tracking coil and a focusing coil may be integrated on the same plane of the coil apparatus, and the size and thickness of the actuator can be effectively reduced.

The invention achieves the above-identified object by providing an actuator of an optical pickup head having horizontal-arranged magnetic field generator and coil apparatus. The optical pickup head is for reading/writing data on a disk. The actuator includes a lens holder, a magnetic field generator and a coil apparatus. The lens holder holds a lens. The magnetic field generator generates a first magnetic field and a second magnetic field. The magnetic field direction of the first magnetic field is perpendicular to a plane of the disk. The magnetic field direction of the second magnetic field is parallel to the plane of the disk.

The magnetic field generator includes a first magnet and a second magnet. The first magnet is horizontally disposed above the lens holder. The first magnet has a first magnetic area, a second magnetic area, a third magnetic area, a fourth magnetic area and a fifth magnetic area. The magnetic surfaces of the first, third and fifth magnetic areas of the first magnet near the lens holder have a first polarity. The magnetic surfaces of the second and fourth magnetic areas of the first magnet near the lens holder have a second polarity.

The second magnet is horizontally disposed below the lens holder. The second magnet has a first magnetic area, a second magnetic area, a third magnetic area, a fourth magnetic area and a fifth magnetic area. The magnetic surfaces of the first and fifth magnetic areas of the second magnet near the lens holder have the first polarity. The magnetic surfaces of the second, third and fourth magnetic areas of the second magnet near the lens holder have the second polarity.

The magnetic field generator forms the first magnetic field according to the reverse polarities of the third magnetic area of the first magnet and the third magnetic area of the second magnet. The magnetic field generator forms the second magnetic field according to the reverse polarities of the first and second magnetic areas of the first magnet, the reverse polarities of the fourth and fifth magnetic areas of the first magnet, the reverse polarities of the first and second magnetic areas of the second magnet and the reverse polarities of the fourth and fifth magnetic areas of the second magnet.

The coil apparatus is horizontally disposed at one side or two sides of the lens holder. The coil apparatus includes a tracking coil and a focusing coil. The tracking coil introduces a first current and generates a first reaction force, which forces the lens holder to move along a tracking direction, according to the first magnetic field.

The focusing coil and the tracking coil are disposed on the same horizontal plane. The focusing coil introduces a second current and generates a second reaction force, which forces the lens holder to move along a focusing direction, according to the second magnetic field.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a top view showing a conventional actuator of an optical pickup head.

FIG. 2 is a side view showing the conventional actuator of the optical pickup head.

FIG. 3 is a pictorial view showing the conventional actuator of the optical pickup head.

FIG. 4 is a side view showing a structure of an actuator of an optical pickup head according to a first embodiment of the invention.

FIG. 5 is a top perspective view showing the actuator of the optical pickup head according to the first embodiment of the invention.

FIG. 6 is a schematic illustration showing a status when a tracking coil is introducing a first current.

FIG. 7 is a schematic illustration showing a status when a focusing coil is introducing a second current.

FIG. 8 is a side view showing a structure of an actuator of an optical pickup head according to a second embodiment of the invention.

FIG. 9 is a top perspective view showing the actuator of the optical pickup head according to the second embodiment of the invention.

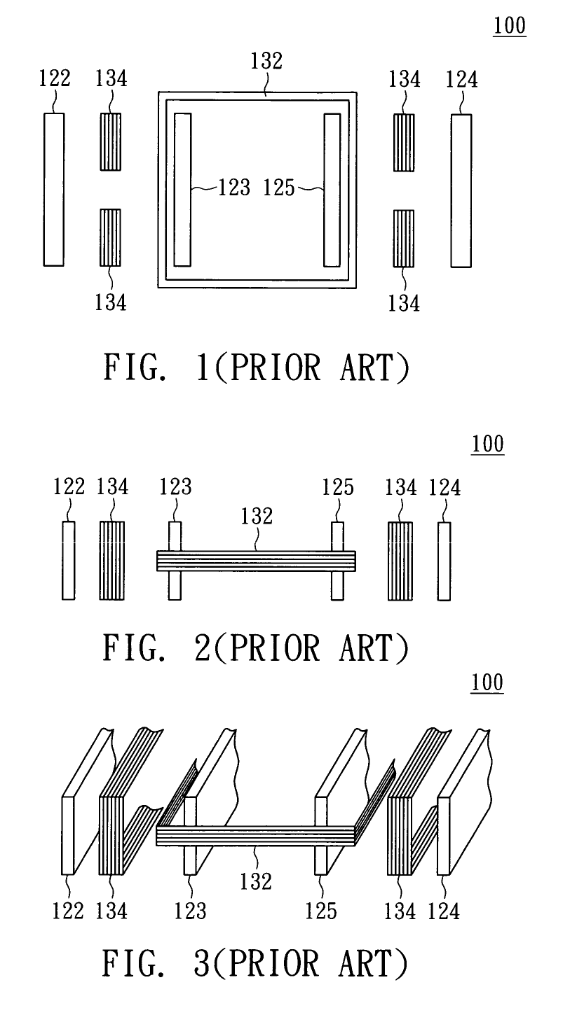

### DETAILED DESCRIPTION OF THE INVENTION

In the era with the rapidly growing technology, the miniaturization of more and more electrical devices is researched and developed in order to enhance the product competitiveness, especially in the field of the optical pickup head of the optical drive. Thus, integrating a tracking coil and a focusing coil on the same plane of a coil apparatus and designing different polarities on the same magnetic surface in the magnetic field generator enable the horizontal-arranged coil apparatus and magnetic field generator to respectively force the lens holder to move along a focusing direction and a tracking direction. Because the magnetic field generator and the coil apparatus are arranged horizontally, the volume and thickness of the actuator of the optical pickup head can be reduced.

### FIRST EMBODIMENT

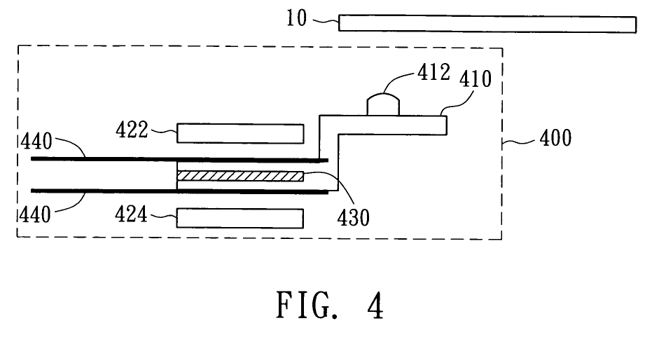

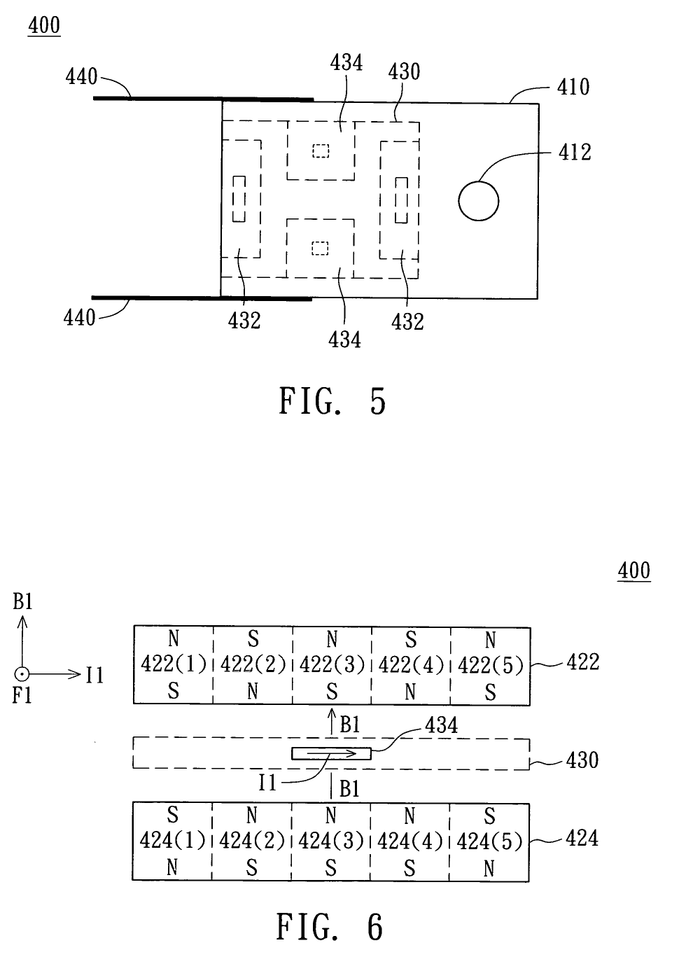

FIG. 4 is a side view showing a structure of an actuator of an optical pickup head according to a first embodiment of the invention. FIG. 5 is a top perspective view showing the actuator of the optical pickup head according to the first embodiment of the invention. Referring to FIGS. 4 and 5, an actuator 400 of an optical pickup head for reading/writing data on data tracks of a disk 10 includes a lens holder 410, a magnetic field generator and a coil apparatus 430. The lens holder 410 is suspended at one side thereof. The lens holder 410 for holding a lens 412 is connected to a suspending apparatus 440 to form a suspended state, and the suspending apparatus 440 may be, for example, a metal wire or an elastic sheet.

The magnetic field generator generates a first magnetic field and a second magnetic field. The magnetic field direction of the first magnetic field is perpendicular to the plane of the disk 10. The magnetic field direction of the second magnetic field is parallel to the plane of the disk 10. The magnetic field generator includes, for example, a first magnet 422 and a second magnet 424. The first magnet 422 is horizontally disposed above the lens holder 410, and the second magnet 424 corresponding to the first magnet 422 is horizontally disposed below the lens holder 410.

The coil apparatus 430 is horizontally disposed at one side of the lens holder 410, and may be made of, for example, a wire or a printed circuit board or may be made by way of plating. The coil apparatus 430 includes a focusing coil 432 and a tracking coil 434. Each of the focusing coil 432 and the tracking coil 434 may be, for example, a rectangular ring coil. When the focusing coil 432 is introducing a second current, the actuator 400 generates a second reaction force, which forces the lens holder 410 to move along a focusing direction, according to the second current and the second magnetic field. When the tracking coil 434 is introducing a first current, the actuator 400 generates a first reaction force, which forces the lens holder 410 to move along a tracking direction, according to the first current and the first magnetic field. The tracking coil 434 and the focusing coil 432 are disposed on the same horizontal plane, as shown in FIG. 5.

The coil apparatus 430 of the actuator 400 includes two focusing coils 432 and two tracking coils 434. In order to enable the focusing coil 432 and the tracking coil 434 to force the lens holder 410, which holds the lens 412, to move along the focusing direction or the tracking direction, the magnetic field generator horizontally disposed above and below the lens holder 410 determines the number of magnetic areas and the polarities of the magnetic areas of the magnetic field generator according to the position of the generator relative to the focusing coil 432 or the tracking coil 434.

FIG. 6 is a schematic illustration showing a status when a tracking coil is introducing a first current. In detail, when the coil apparatus 430 is configured as shown in FIG. 5, the magnetic areas of the first magnet 422 may include a first magnetic area 422 (1), a second magnetic area 422 (2), a third magnetic area 422 (3), a fourth magnetic area 422 (4) and a fifth magnetic area 422 (5). The magnetic areas of the second magnet 424 may include a first-magnetic area 424 (1), a second magnetic area 424 (2), a third magnetic area 424 (3), a fourth magnetic area 424 (4) and a fifth magnetic area 424 (5). The magnetic areas in each of the first magnet 422 and the second magnet 424 correspond to the coil apparatus 430 and are arranged linearly.

One side of each of the first magnetic area 422 (1), the third magnetic area 422 (3), the fifth magnetic area 422 (5) of the first magnet 422 near the coil apparatus 430, and one side of each of the first magnetic area 424 (1) and the fifth magnetic area 424 (5) of the second magnet 424 near the coil apparatus 430 are configured to have a first polarity, such as the S polarity. One side of each of the second magnetic area 422 (2) and the fourth magnetic area 422 (4) of the first magnet 422 near the coil apparatus 430, and one side of the second magnetic area 424 (2), the third magnetic area 424 (3) and the fourth magnetic area 424 (4) of the second magnet 424 near the coil apparatus 430 are configured to have a second polarity, such as the N polarity.

The magnetic field generator can form a first magnetic field B1 by designing one side of the third magnetic area 422 (3) of the first magnet 422 near the coil apparatus 430 into the S polarity while designing one side of the third magnetic area 424 (3) of the second magnet 424 near the coil apparatus 430 into the N polarity. The magnetic field direction of the first magnetic field B1 is perpendicular to the plane of the coil apparatus 430. If a first current I1 is introduced into the tracking coil 434 under the action of the first magnetic field B1, the first current I1 and the first magnetic field B1 form a first reaction force F1. Because the suspending apparatus 440 makes the lens holder 410 into the suspended state, the first reaction force F1 may force the lens holder 410 to move along the tracking direction.

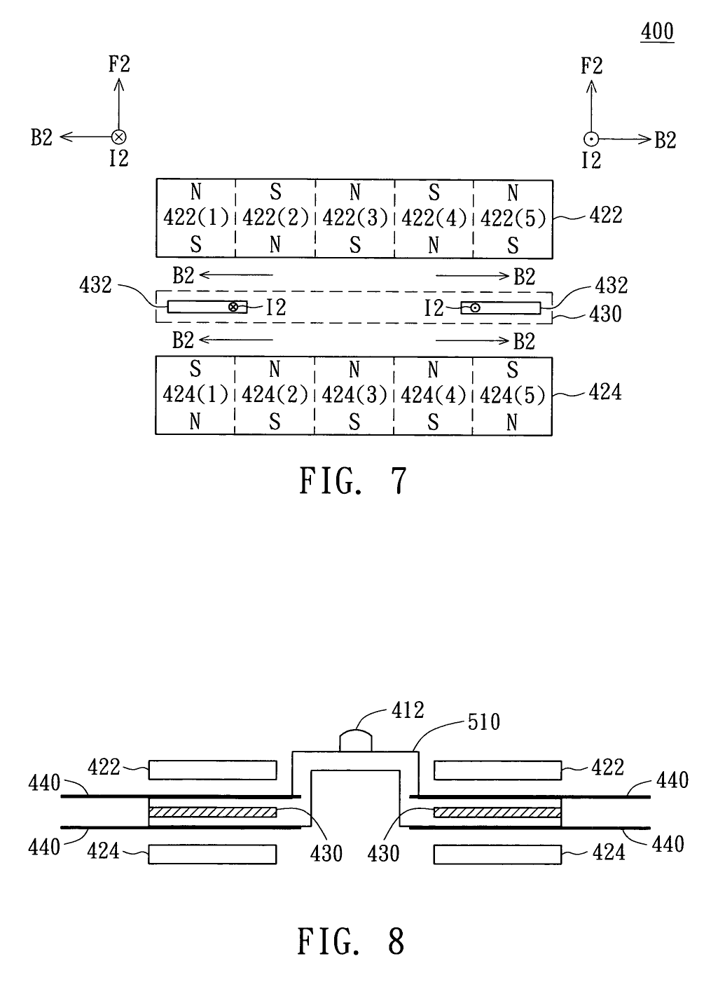

FIG. 7 is a schematic illustration showing a status when a focusing coil is introducing a second current. Similarly, one side of each of the first magnetic area 422 (1) and the fifth magnetic area 422 (5) of the first magnet 422 near the coil apparatus 430, and one side of each of the first magnetic area 424 (1) and the fifth magnetic area 424 (5) of the second magnet 424 near the coil apparatus 430 are configured to have the S polarity. One side of each of the second magnetic area 422 (2) and the fourth magnetic area 422 (4) of the first magnet 422 near the coil apparatus 430, and one side of each of the second magnetic area 424 (2) and the fourth magnetic area 424 (4) of the second magnet near the coil apparatus 430 are configured to have the N polarity. Thus, the magnetic field generator can form a second magnetic field B2 having a magnetic field direction parallel to the plane of the coil apparatus 430.

If a second current I2 is introduced into the focusing coil 432 under the action of the magnetic field of the second magnetic field B2, the actuator 400 generates a second reaction force F2, which forces the lens holder 410 to move along the focusing direction, according to the second current I2.

The reaction forces that are perpendicular to each other drive the lens holder to move along the tracking direction or the focusing direction so as to read or write data. The lens holder is not particularly limited to that as described in the first embodiment. Instead, the effect of the invention may also be achieved when the lens holder is properly modified.

### SECOND EMBODIMENT

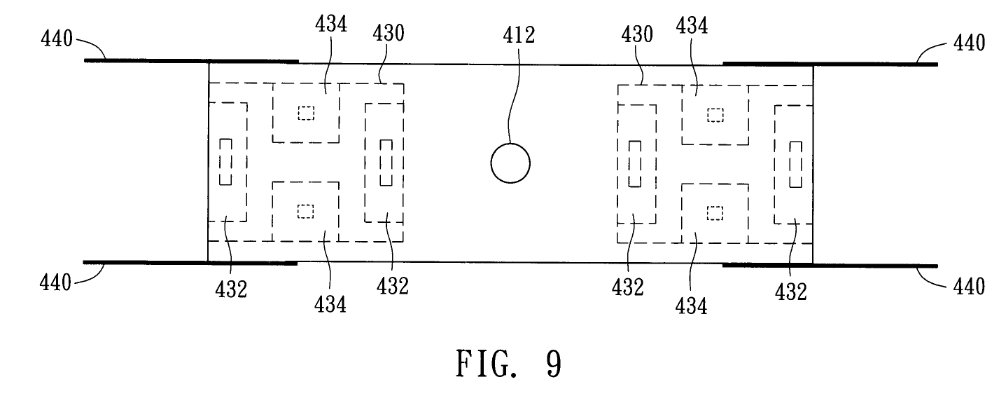

FIG. 8 is a side view showing a structure of an actuator of an optical pickup head according to a second embodiment of the invention. FIG. 9 is a top perspective view showing the actuator of the optical pickup head according to the second embodiment of the invention. The lens holder of the invention is not particularly limited to that of FIG. 4 of the first embodiment, in which the lens holder is suspended at one side. When the exterior design of the lens holder is changed, the coil apparatus, the magnetic field generator and the suspending apparatus may be modified in correspondence with the modification of the lens holder, and thus be disposed at two sides of the lens holder.

For example, when the lens holder 510 is suspended at both sides, as shown in FIG. 8, the coil apparatus 430, the first magnet 422, the second magnet 424, the first yoke 452, the second yoke 454 and the suspending apparatus 440 of the first embodiment may be disposed at two sides of the lens holder 510 according to the design of the lens holder 410.

The embodiments of the invention disclose the actuator of the optical pickup head having the horizontal-arranged magnetic field generator and coil apparatus. The size and thickness of the actuator can be effectively reduced because the tracking coil and the focusing coil are integrated on the same plane of the coil apparatus, and the coil apparatus and the magnetic field generator are arranged horizontally. Thus, the invention may be further applied to the small form factor optical disk drive (SFFO) through the reduction of the size and thickness of the optical pickup head.

While the invention has been described by way of examples and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An actuator of an optical pickup head for reading/writing data on a disk, the actuator comprising:
a lens holder for holding a lens;
a magnetic field generator for generating a first magnetic field, which has a magnetic field direction perpendicular to a plane of the disk, and a second magnetic field, which has a magnetic field direction parallel to the plane of the disk, wherein the magnetic field generator comprises:
a first magnet, which is horizontally disposed above the lens holder and has a first magnetic area, a second magnetic area, a third magnetic area, a fourth magnetic area and a fifth magnetic area, wherein magnetic surfaces of the first magnetic area, the third magnetic area and the fifth magnetic area near the lens holder have a first polarity, and magnetic surfaces of the second magnetic area and the fourth magnetic area near the lens holder have a second polarity; and
a second magnet, which is horizontally disposed below the lens holder and has a first magnetic area, a second magnetic area, a third magnetic area, a fourth magnetic area and a fifth magnetic area, wherein magnetic surfaces of the first magnetic area and the fifth magnetic area near the lens holder have the second polarity, and magnetic surfaces of the second magnetic area, the third magnetic area and the fourth magnetic area near the lens holder have the first polarity; and
a coil apparatus, which is horizontally disposed at one side of the lens holder and comprises:
a tracking coil for introducing a first current and generating a first reaction force, which forces the lens holder to move along a tracking direction, according to the first magnetic field; and
a focusing coil for introducing a second current and generating a second reaction force, which forces the lens holder to move along a focusing direction, according to the second magnetic field, wherein:
the focusing coil and the tracking coil are disposed on the same horizontal plane;
the first magnetic field is formed between the third magnetic area of the first magnet and the third magnetic area of the second magnet; and
the second magnetic field is formed between the first magnetic area of the first magnet and the second magnetic area of the first magnet, between the fourth magnetic area of the first magnet and the fifth magnetic area of the first magnet, between the first magnetic area of the second magnet and the second magnetic area of the second magnet, and between the fourth magnetic area of the second magnet and the fifth magnetic area of the second magnet.

2. The actuator according to claim 1, wherein the focusing direction is perpendicular to the plane of the disk.

3. The actuator according to claim 1, wherein the tracking direction and the focusing direction are perpendicular to each other.

4. The actuator according to claim 1, wherein the actuator comprises two sets of the coil apparatus, which are horizontally disposed at one side and the other side of the lens holder.

5. The actuator according to claim 1, wherein the coil apparatus is made by way of wire winding.

6. The actuator according to claim 1, wherein the coil apparatus is made of a printed circuit board.

7. The actuator according to claim 1, wherein the first magnetic area of the first magnet, the second magnetic area of the first magnet, the third magnetic area of the first magnet, the fourth magnetic area of the first magnet and the fifth magnetic area of the first magnet are linearly arranged in correspondence with the coil apparatus, and the first magnetic area of the second magnet, the second magnetic area of the second magnet, the third magnetic area of the second magnet, the fourth magnetic area of the second magnet and the fifth magnetic area of the second magnet are linearly arranged in correspondence with the coil apparatus.

8. The actuator according to claim 1, wherein the actuator comprises two sets of the magnetic field generator, which are horizontally disposed at one side and the other side of the lens holder.

9. The actuator according to claim 1, further comprising a yoke apparatus, which comprises:
a first yoke horizontally disposed above the first magnet; and
a second yoke horizontally disposed below the second magnet.

10. The actuator according to claim 9, wherein the actuator comprises two sets of the first and second yoke apparatuses, which are horizontally disposed at one side and the other side of the lens holder.

11. The actuator according to claim 7, wherein the first magnet is a multi-polarity magnet.

12. The actuator according to claim 7, wherein the second magnet is a multi-polarity magnet.

13. The actuator according to claim 1, wherein the disk has a plurality of data tracks and the first reaction force forces the lens to focus on one of the data tracks.

14. The actuator according to claim 1, wherein the coil apparatus and the magnetic field generator are horizontally disposed in an up-and-down manner.

15. The actuator according to claim 1, further comprising a suspending apparatus connected to the lens holder to suspend the lens holder into a suspended state.

16. The actuator according to claim 15, wherein the suspending apparatus is a metal wire.

17. The actuator according to claim 15, wherein the suspending apparatus is an elastic sheet.

18. The actuator according to claim 1, wherein the tracking coil is a rectangular ring coil.

19. The actuator according to claim 1, wherein the focusing coil is a rectangular ring coil.

20. The actuator according to claim 1, wherein the coil apparatus is horizontally disposed between the first magnet and the second magnet.
